(19) United States
(12) Patent Application Publication
(10) Pub. No.: US 2006/0122050 A1
(43) Pub. Date: Jun. 8, 2006

(54) Stretched glass with high birefringence

(76) Inventors: Nicholas F. Borrelli, Elmira, NY (US); Robert M. Morena, Lindley, NY (US); David L. Morse, Corning, NY (US)

Correspondence Address: CORNING INCORPORATED, SP-TI-3-1, CORNING, NY, 14831, US

(21) Appl. No.: 11/007,431

(22) Filed: Dec. 7, 2004

(51) Int. Cl. C03C 3/11; C03C 3/091

(52) U.S. Cl. 501/56; 501/66; 65/32.3; 65/32.5

(57) ABSTRACT

The invention is directed to a birefringent glass having a R₂O—Al₂O₃—B₂O₃—SiO₂ base composition, where R₂O represents alkali metal oxides, and a precipitated silver halide phase with a volume fraction of at least 0.001. The birefringent glass composition of the invention can be used to produce monolithic zero-order wave plates having a thickness less than 2 mm. These wave plates can be used to introduce a phase shift between polarized components of light transmitted through the glass.

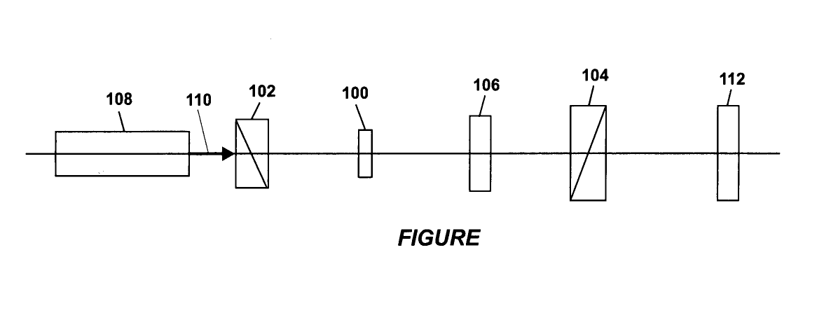

### FIELD OF THE INVENTION

The invention relates to birefringent glasses and use of the same as wave plates.

### BACKGROUND OF THE INVENTION

Wave plates, also called linear phase retarders or retardation plates, introduce a phase shift between polarized components of light transmitted through the plate. The birefringent property of the wave plate causes the light to split into an ordinary ray and an extraordinary ray. The two rays travel at different velocities in the plate. The path difference, kλ, expressed in wavelengths, between the two rays is given by:
kλ=±l(nₑ−nₒ)
where nₑ is the refractive index of the extraordinary ray, nₒ is the refractive index of the ordinary ray, l is the physical thickness of the wave plate, λ is the wavelength of the ray, and k can be considered as the retardation expressed in fractions of a wavelength. The difference in velocities of the rays results in a phase difference, also called plate retardation, when the two rays recombine. The phase difference, δ, between two rays traveling through a birefringent material is 2π/λ times the path difference:

$$δ = \pm \frac{2 π}{λ} l ( {n}_{e} - {n}_{o} ) \qquad ( 2 )$$

Wave plates are characterized based on the phase difference introduced between the ordinary and extraordinary rays. For a half-wave plate, δ=(2 m+1)π, i.e., an odd multiple of π. For a quarter-wave plate, δ=(2 m+1)π/2, i.e., an odd multiple of π/2. For a full-wave plate, δ=2 mπ. For the full-, half-, and quarter-wave plates, the order of the wave plate is given by the integer m. When m=0, the term zero-order wave plate is used. When m>0, the term multiple-order wave plate is used. A wave plate having the zero-order property produces retardation that is less sensitive to variations in operating conditions, such as variation in angle of incidence or temperature. Wave plates are usually made from uniaxial crystalline materials such as calcite. Crystalline materials, because of their very large birefringence, require zero-order wave plates to be impractically thin, e.g., on the order of 25 μm. In practice, two slices of uniaxial crystals with opposite orientations have to be combined together to produce a net zero-order performance in a reasonable thickness.

The ability to produce zero-order retardation in a monolithic structure is highly desirable. U.S. Pat. No. 5,375,012 (issued to Borrelli et al.) discloses a zero-order wave plate in a monolithic structure. The wave plate is composed of a birefringent glass, which is produced by stretching a phase-separated or photochromic glass containing silver halide particles at an elevated temperature. The applied stress elongates the silver halide particles and generates form birefringence in the glass. Borrelli et al. disclose that zero-order wave plates having thicknesses of 0.5 to 1.5 mm are possible with wavelengths in the visible range, but that somewhat greater thicknesses may be required in the infrared range. Heretofore, it has been difficult to produce stretched glasses with sufficient birefringence to make zero-order half wave plates in convenient thicknesses at 1550 nm. Thicknesses usually have to be greater than 2 mm with standard glass compositions (N. F. Borrelli and C. L. Davis, SPIE vol. 1746, pages 336-342, 1992). The ability to make zero-order half wave plates from stretched glasses in thicknesses less than 2 mm at 1550 nm is desired.

### BRIEF SUMMARY OF THE INVENTION

In one aspect, the invention relates to a birefringent glass having a R₂O—Al₂O₃—B₂O₃—SiO₂ base composition, where R₂O represents alkali metal oxides, and a precipitated silver halide phase with a volume fraction of at least 0.001.

In one embodiment, the volume fraction of the silver halide phase is in a range from 0.001 to 0.01.

In one embodiment, the glass composition comprises silver in an amount of 0.25 to 0.50 wt % and chlorine and bromine in a total amount of 0.20 to 0.80 wt %.

In one embodiment, the glass composition comprises 50 to 65 wt % SiO₂, 15 to 25 wt % B₂O₃, 5 to 12 wt % Al₂O₃, 0 to 5 wt % Na₂O, 0 to 5 wt % Li₂O, 0 to 15 wt % K₂O, 0.25 to 0.50 wt % Ag, 0.015 to 0.025 wt % CuO, 0.10 to 0.20 wt % PbO, 0.10 to 0.50 wt % Cl⁻, and 0.10 to 0.30 wt % Br⁻.

In a preferred embodiment, the glass composition comprises 55.7 to 62.7 wt % SiO₂, 16.6 to 20.9 wt % B₂O₃, 7.7 to 10.2 wt % Al₂O₃, 1.6 to 3.2 wt % Na₂O, 1.8 to 2.0 wt % Li₂O, 5.7 to 10.4 wt % K₂O, 0.30 to 0.41 wt % Ag, 0.016 to 0.020 wt % CuO, 0.10 to 0.12 wt % PbO, 0.15 to 0.30 wt % Cl⁻, and 0.12 to 0.20 wt % Br⁻.

The glass composition may further comprise one or more components selected from the group consisting of TiO₂, La₂O₃, P₂O₅, and ZrO₂ in a total amount not exceeding 10 wt %.

In one embodiment, the birefringent glass has a birefringence of at least 4×10⁻⁴ at 1550 nm.

In one embodiment, the birefringent glass has silver metal phase below detection limit.

In another aspect, the invention relates to a wave plate composed of a birefringent glass having a R₂O—Al₂O₃—B₂O₃—SiO₂ base composition, where R₂O represents alkali metal oxides, and a precipitated silver halide phase with a volume fraction of at least 0.001.

In another aspect, the invention relates to a method of making a birefringent glass for a wave plate. The method comprises melting a glass batch having a R₂O—Al₂O₃—B₂O₃—SiO₂ base composition, where R₂O represents alkali metal oxides, and comprising silver, chlorine, and bromine, wherein silver is present in an amount of at least 0.25 wt % and chlorine and bromine are present in a total amount of at least 0.2 wt %. The method also includes precipitating a silver halide phase in the glass in an amount that constitutes a volume fraction of at least 0.001. The method also includes subjecting the glass to a stress to elongate the silver halide particles therein.

Other features and advantages of the invention will be apparent from the following description and the appended claims.

### BRIEF DESCRIPTION OF THE DRAWINGS

The only accompanying FIGURE is a schematic of a measurement setup for phase shift.

### DETAILED DESCRIPTION OF THE INVENTION

The invention will now be described in detail with reference to a few preferred embodiments. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the only accompanying FIGURE and discussions that follow.

A phase-separated glass is a glass which, upon heat treatment, separates into at least two phases: a separated phase in the form of particles, either amorphous or crystalline, dispersed in a matrix phase. When the glass is stretched, the particles elongate, generating a form birefringence in the glass. It can be shown that the extent of the form birefringence in a stretched glass containing silver halide particles is determined by the aspect ratio of the elongated halide particles and the number density of the particles. In the asymptotic limit the value of the form birefringence, f, is given by the following expression:

$$f = {n}_{a} - {n}_{b} = {V}_{f} \frac{{( ɛ - 1 )}^{2}}{4 n ( ɛ + 1 )} \qquad ( 3 )$$

where V_{f} is the volume fraction of the halide phase, na is the refractive index along a direction parallel to the stretched direction, n_{b} is the refractive index along a direction perpendicular to the stretched direction, n is the average refractive index of the surrounding glass medium, and ε is the dielectric constant of the halide phase normalized to that of the surrounding glass medium (N. F. Borrelli and C. L. Davis, SPIE vol. 1746, pages 336-342, 1992). Thus, the larger the volume fraction of the halide phase, the larger the birefringence. Further, the larger the birefringence, the smaller the thickness of the wave plate has to be to achieve the desired retardation.

Embodiments of the invention provide glass compositions that produce a high volume fraction of the silver halide phase. Typical volume fractions are in a range from 0.001 to 0.01. Glasses according to embodiments of the invention contain silver bromide and/or chloride particles. For wave plate purposes, stress can be applied to the glass at an elevated temperature to render it birefringent. Large birefringence on the order of 5×10⁻⁴ at 546-nm has been achieved. Birefringence at 1550 nm is on the order of 4×10⁻⁴. The magnitude of the birefringence permits producing a zero-order wave plate in a monolithic body in a practical thickness. With wavelengths in the visible range, plate thicknesses of 0.5 mm to 0.6 mm are possible. With wavelengths in the infrared range, plate thicknesses of 1.5 mm to 2.0 mm are possible.

A glass according to an embodiment of the invention may or may not be photochromic. The base glass is preferably R₂O—Al₂O₃—B₂O₃—SiO₂, where R₂O represents alkali metal oxides. The glass batch contains a source of silver and at least one source of halogen selected from bromine and chlorine. Preferably, the glass batch includes sources of chlorine and bromine. The glass batch may also include additives such as CuO, Pb₂O₅, La₂O₃, TiO₂, and ZrO₂. The actual batch ingredients may include materials, either the oxides or other compounds, which when melted in combination with the other components will be converted into the desired oxide in the proper proportions.

A preferred glass composition according to one embodiment of the invention includes 50 to 65 wt % SiO₂, 15 to 25 wt % B₂O₃, 5 to 12 wt % Al₂O₃, 0 to 5 wt % Na₂O, 0 to 5 wt % Li₂O, 0 to 15 wt % K₂O, 0.25 to 0.50 wt % Ag, 0.015 to 0.025 wt % CuO, 0.10 to 0.20 wt % PbO, 0.10 to 0.50 wt % Cl⁻, and 0.10 to 0.30 wt % Br⁻. The glass composition may also include other components, such as TiO₂, La₂O₃, P₂O₅, and ZrO₂. Preferably, the sum of these components, if present, do not exceed 10 wt % in total. Preferably, the sum of all alkalis in the glass composition is in a range from 8 to 20%.

A more preferred glass composition range is as follows: 55.7 to 62.7 wt % SiO₂, 16.6 to 20.9 wt % B₂O₃, 7.7 to 10.2 wt % Al₂O₃, 1.6 to 3.2 wt % Na₂O, 1.8 to 2.0 wt % Li₂O, 5.7 to 10.4 wt % K₂O, 0.30 to 0.41 wt % Ag, 0.016 to 0.020 wt % CuO, 0.10 to 0.12 wt % PbO, 0.15 to 0.30 wt % Cl⁻, and 0.12 to 0.20 wt % Br⁻. The glass composition may also include other components, such as TiO₂, La₂O₃, P₂O₅, and ZrO₂. Preferably, the sum of these components, if present, do not exceed 10 wt % in total. Preferably, the sum of all alkalis in the glass composition is in a range from 8 to 20%.

The silver halide phase may be precipitated in the glasses of the present invention as the appropriate melted glass batches are cooled. However, it is generally desirable to cool the melted glass batches rapidly and then reheat the cooled glass to precipitate the silver halide phase. To this end, the glass is heated above its strain point. Generally, a temperature in the range of 600° C. to 700° C. is preferred for this purpose, although temperatures in the range of 600° C. to 800° C. are contemplated. Preferred heat treatment temperature is 660° C. Glass compositions according to the invention have a volume fraction of the silver halide phase of at least 0.001. Typically, the volume fraction of the silver halide phase is in a range from 0.001 to 0.01. A birefringent glass is made by subjecting the glass in which silver halide particles have been precipitated to stress. This usually involves applying a pulling force to the glass. The aspect ratio of the silver halide particles after the glass is subjected to stress should preferably be greater than 5:1.

Examples of glasses according to embodiments of the invention are shown in Table 1. These glasses were made by melting the appropriate glass batches and shaping the melt into glass bodies. The glass bodies were then re-melted, poured into patties, annealed, and core-drilled into 1″ disks. These disks were then heated to 725° C. in a lab extruder for strike-in, cooled to 635° C., and extruded into 4-mm solid tubing at 635° C. Table 1 shows the long-time X-ray Diffraction (XRD) data for any silver-halide and silver metal phases precipitated during strike-in. Glass F precipitated a large amount of the silver-halide phase without any XRD evidence of silver metal precipitation. The greater tendency of Ag to form halide phase in Glass F rather than precipitate as the metal may be related to the low value of R-factor for Glass F compared to the other glasses. The R-factor is a measure of the fraction of boron groups that are associated with alkali cations in the glass. This factor may, in turn, control the number of halide species available bonding to Ag ions. R-factor is expressed in cation % on an oxide basis as calculated from the formula:

$$R = \frac{{M}_{2} O + 2 MO - {Al}_{2} {O}_{3}}{{B}_{2} {O}_{3}} \qquad ( 4 )$$

where M₂O designates alkali metal oxides and MO designates alkaline earth metal oxides. The preferred range for R-factor is 0.20 to 0.50, with the most preferred values in the range of 0.25 to 0.35.

TABLE 1

| | Composition (wt %) | | | | | |
|---|---|---|---|---|---|---|
| | A | B | C | D | E | F |
| SiO₂ | 58.1 | 55.7 | 57.3 | 55.5 | 58.0 | 55.6 |
| B₂O₃ | 18.2 | 20.9 | 18.2 | 20.7 | 18.1 | 20.8 |
| Al₂O₃ | 9.5 | 8.7 | 9.5 | 10.2 | 10.2 | 9.6 |
| Na₂O | 1.7 | 1.7 | 1.8 | 1.6 | 1.6 | 1.6 |
| Li₂O | 1.9 | 1.9 | 2.0 | 1.8 | 1.8 | 1.8 |
| K₂O | 9.6 | 10.1 | 10.3 | 9.3 | 9.3 | 9.6 |
| Ag | 0.41 | 0.41 | 0.41 | 0.41 | 0.41 | 0.41 |
| CuO | 0.016 | 0.016 | 0.016 | 0.016 | 0.016 | 0.016 |
| Cl⁻ | 0.30 | 0.30 | 0.30 | 0.29 | 0.30 | 0.30 |
| Br⁻ | 0.16 | 0.16 | 0.16 | 0.16 | 0.16 | 0.16 |
| PbO | 0.12 | 0.12 | 0.12 | 0.12 | 0.12 | 0.12 |
| XRD peak | 0.90* | 0.90* | 1.00* | 0.90* | 0.80* | 0.90 |
| height ratio, | | | | | | |
| AgX:glass | | | | | | |

*Ag metal XRD peaks also observed

In one study, Glass F was re-melted as a 20-lb melt and poured into a 32-inch bar. The bar was heat-treated to 730° C. to strike-in the Ag-halide phase and then machined to a 4.0-in (width)×0.44-in (thickness)×30-in (length) bar. The bar was redrawn using a range of temperatures, with test strips collected over a range of temperatures and pulling loads. The maximum pull stress was approximately 4000 psi at 595° C. The thickness of the finished pieces were of the order of 1.8 mm. Phase shift measurements were made on the test strips.

A standard testing procedure was employed, as illustrated schematically in the only accompanying FIGURE. In the FIGURE, a test strip 100 is inserted between crossed polarizer 102 and analyzer 104. The test strip 100 is rotated at 45° with respect to the polarizer 102. A quarter-wave plate 106 is inserted between the test strip 100 and the analyzer 104. The quarter-wave plate 106 is aligned with either of the optic axes of the test strip 100. A light source 108, such as a laser, generates a light beam 110, which passes through the polarizer 102, test strip 100, and quarter-wave plate 106 to the analyzer 104. If the system is not at null, the light beam 110 exits the analyzer 104 and is detected by the detector 112. The angle the analyzer 104 is rotated from the crossed 900 position to produce a null provides a measure of the phase shift of the test strip 100.

The intensity of the light beam 110 as a function of the angle of the analyzer 104 relative to the polarizer 102 is given by the following expression:

$$I ( θ ) = \frac{1 + cos ( 2 θ + δ )}{2} \qquad ( 5 )$$

where δ is the phase difference of the birefringent medium and θ is the angle of the analyzer. It can be easily seen that the intensity goes to zero (null point) when the argument of the cosine reaches 180°. This is equivalent to the condition that the angle of rotation relative to the original crossed position, θ=90°, is Δθ=δ/2

For a birefringent medium that is dichroic, there is unequal transmission in the two directions corresponding to the optic axes. Equation (5) can be modified to account for dichroism as follows:

$$I ( θ ) = \frac{exp ( - α / 2 )}{2} [ cosh ( α / 2 ) + cos ( 2 θ + δ ) ] \qquad ( 6 )$$

The parameter α is used to characterize the extent of the dichroism, and cosh is the hyperbolic cosine of (α/2). The term a is defined by the following expression:

$$α = ln \frac{{T}_{low}}{{T}_{high}} \qquad ( 7 )$$

where Tₘᵢₙ is the transmittance measured in a direction parallel to the stretched direction and Tₘₐₓ is the transmittance measured in a direction perpendicular to the stretched direction.

It is clear from equation (6) that the null condition can never be achieved, because this would require that
cos(2θ+δ)−cosh(α/2) (8)
This condition can never be met since the cosh is always greater than one. However, the minimum in the transmittance still occurs at the condition corresponding to equation (5). This can easily be shown by taking the derivative of equation (6) and setting it equal to zero. Thus, the major effect of dichroism on the measurement of birefringence is the weakening of the so-called null condition. It is no longer a true null, but a minimum. Thus, the estimates of the phase shift can still be obtained by the method described above.

Table 2 shows measurement results for three test strips at 546-nm. Birefringence at 1550 nm is about 80% of the values reported in Table 2. Measurement results of a sample of a standard polarizing glass drawn to 1 mm is also included for reference. The reference sample has the following composition: 58.1 wt % SiO₂, 18.2 wt % B₂O₃, 9.5 wt % Al₂O₃, 1.6 wt % Na₂O, 1.8 wt % Li₂O, 9.6 wt % K₂O, 0.32 wt % ZrO₂, 0.31 wt % Ag, 0.016 wt % CuO, 0.30 wt % Cl⁻, 0.15 wt % Br⁻, and 0.11 wt % PbO. Table 2 shows an increase in birefringence of the test strips of almost a factor of two over the reference sample. The half-wave plate thickness at 1550 nm would be on the order of 1.5 mm.

TABLE 2

| | Retardation | | Phase Difference | Δn |
|---|---|---|---|---|
| | (mm) | Thickness (mm) | (Degrees/mm) | (×10⁻⁴) |
| Strip 1 | 249 | 0.5 | 368 | 5 |
| Strip 2 | 260 | 0.5 | 342 | 5.2 |
| Strip 3 | 243 | 0.5 | 320 | 4.9 |
| Standard | | | | 2.9 |

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A birefringent glass having a R₂O—Al₂O₃—B₂O₃—SiO₂ base composition, where R₂O represents alkali metal oxides, and a precipitated silver halide phase with a volume fraction of at least 0.001.

2. The birefringent glass of claim 1, wherein the volume fraction of the silver halide phase is in a range from 0.001 to 0.01.

3. The birefringent glass of claim 1, wherein the glass composition comprises silver in an amount of 0.25 to 0.50 wt % and chlorine and bromine in a total amount of 0.20 to 0.80 wt %.

4. The birefringent glass of claim 1, wherein the glass composition comprises 50 to 65 wt % SiO₂, 15 to 25 wt % B₂O₃, 5 to 12 wt % Al₂O₃, 0 to 5 wt % Na₂O, 0 to 5 wt % Li₂O, 0 to 15 wt % K₂O, 0.25 to 0.50 wt % Ag, 0.015 to 0.025 wt % CuO, 0.10 to 0.20 wt % PbO, 0.10 to 0.50 wt % Cr⁻, and 0.10 to 0.30 wt % Br⁻.

5. The birefringent glass of claim 4, wherein the glass composition further comprises one or more components selected from the group consisting of TiO₂, La₂O₃, P₂O₅, and ZrO₂ in a total amount not exceeding 10 wt %.

6. The birefringent glass of claim 4, wherein the sum of all alkali in the glass composition is in a range from 8 to 20%.

7. The birefringent glass of claim 1, wherein the glass composition comprises 55.7 to 62.7 wt % SiO₂, 16.6 to 20.9 wt % B₂O₃, 7.7 to 10.2 wt % Al₂O₃, 1.6 to 3.2 wt % Na₂O, 1.8 to 2.0 wt % Li₂O, 5.7 to 10.4 wt % K₂O, 0.30 to 0.41 wt % Ag, 0.016 to 0.020 wt % CuO, 0.10 to 0.12 wt % PbO, 0.15 to 0.30 wt % Cl⁻, and 0.12 to 0.20 wt % Br⁻.

8. The birefringent glass of claim 1, having a birefringence of at least 4×10⁻⁴ at 1550 nm.

9. The birefringent glass of claim 1, having silver metal phase below detection limit.

10. A wave plate composed of a birefringent glass having a R₂O—Al₂O₃—B₂O₃—SiO₂ base composition, where R₂O represents alkali metal oxides, and a precipitated silver halide phase with a volume fraction of at least 0.001.

11. The wave plate of claim 10, wherein the volume fraction of the silver halide phase is in a range from 0.001 to 0.01.

12. The wave plate of claim 10, which produces a zero-order retardation.

13. The wave plate of claim 12, which is a half-wave plate.

14. The wave plate of claim 13, which has a thickness in a range from 1.5 to 2.0 mm at 1550 nm.

15. The wave plate of claim 10, wherein a composition of the birefringent glass comprises 50 to 65 wt % SiO₂, 15 to 25 wt % B₂O₃, 5 to 12 wt % Al₂O₃, 0 to 5 wt % Na₂O, 0 to 5 wt % Li₂O, 0 to 15 wt % K₂O, 0.25 to 0.50 wt % Ag, 0.015 to 0.025 wt % CuO, 0.10 to 0.20 wt % PbO, 0.10 to 0.50 wt % Cl⁻, and 0.10 to 0.30 wt % Br⁻.

16. The wave plate of claim 10, wherein a composition of the birefringent glass comprises 55.7 to 62.7 wt % SiO₂, 16.6 to 20.9 wt % B₂O₃, 7.7 to 10.2 wt % Al₂O₃, 1.6 to 3.2 wt % Na₂O, 1.8 to 2.0 wt % Li₂O, 5.7 to 10.4 wt % K₂O, 0.30 to 0.41 wt % Ag, 0.016 to 0.020 wt % CuO, 0.10 to 0.12 wt % PbO, 0.15 to 0.30 wt % Cl⁻, and 0.12 to 0.20 wt % Br⁻.

17. A method of making a birefringent glass for a wave plate, comprising:
melting a glass batch having a R₂O—Al₂O₃—B₂O₃—SiO₂ base composition, where R₂O represents alkali metal oxides, and comprising silver, chlorine, and bromine, wherein silver is present in an amount of at least 0.25 wt % and chlorine and bromine are present in a total amount of at least 0.2 wt %;
precipitating a silver halide phase in the glass in an amount that constitutes a volume fraction of at least 0.001; and
subjecting the glass to a stress to elongate the silver halide particles therein.

18. The method of claim 17, wherein precipitating the silver halide phase comprises rapidly cooling and reheating the melted glass.

19. The method of claim 17, wherein the glass batch comprises 50 to 65 wt % SiO₂, 15 to 25 wt % B₂O₃, 5 to 12 wt % Al₂O₃, 0 to 5 wt % Na₂O, 0 to 5 wt % Li₂O, 0 to 15 wt % K₂O, 0.25 to 0.50 wt % Ag, 0.015 to 0.025 wt % CuO, 0.10 to 0.20 wt % PbO, 0.10 to 0.50 wt % Cl⁻, and 0.10 to 0.30 wt % Br⁻.

20. The method of claim 17, wherein the glass batch comprises 55.7 to 62.7 wt % SiO₂, 16.6 to 20.9 wt % B₂O₃, 7.7 to 10.2 wt % Al₂O₃, 1.6 to 3.2 wt % Na₂₀, 1.8 to 2.0 wt % Li₂O, 5.7 to 10.4 wt % K₂O, 0.30 to 0.41 wt % Ag, 0.016 to 0.020 wt % CuO, 0.10 to 0.12 wt % PbO, 0.15 to 0.30 wt % Cl⁻, and 0.12 to 0.20 wt % Br⁻.
